(19) United States
(12) Patent Application Publication
(10) Pub. No.: US 2026/0052316 A1
(43) Pub. Date: Feb. 19, 2026

(54) METHOD FOR DETERMINING AN EXPOSURE TIME INTERVAL FOR A CAMERA OF A CAMERA SYSTEM, CAMERA SYSTEM

(71) Applicant: Robert Bosch GmbH, Stuttgart (DE)

(72) Inventor: Wolfgang Niehsen, Bad Salzdetfurth (DE)

(21) Appl. No.: 19/278,979

(22) Filed: Jul. 24, 2025

(30) Foreign Application Priority Data
Aug. 7, 2024 (DE) 10 2024 207 511.6

(51) Int. Cl. H04N 23/81; G03B 7/00; G03B 17/56; H04N 23/68

(52) U.S. Cl. CPC H04N 23/81; G03B 7/00; G03B 17/561; H04N 23/6812; H04N 23/685

(57) ABSTRACT

A method for determining an exposure time for a camera of a camera system that is moving and/or used in a moving scene for automatic object recognition, wherein a specified minimum angular image resolution is maintained. The method includes: determining an effective angular image resolution as a function of the exposure time; determining a maximum permissible exposure time as the exposure time with which the effective angular image resolution takes the value of the minimum angular image resolution; setting the exposure time to a value less than or equal to the maximum permissible exposure time. A camera system is also described.

### FIELD

The present invention relates to a method for determining an exposure time for a camera of a camera system that is preferably moving and/or used for automatic object recognition in a moving scene. The present invention further relates to a camera system.

### BACKGROUND INFORMATION

Driver assistance systems and autonomous driving systems in vehicles comprise optical systems, typically camera systems, whose recorded data are digitally processed. Of particular importance in digital processing is computer-aided object recognition, which is used to identify other vehicles, pedestrians, and much more in a recorded camera image. The design of the camera systems used for this purpose is a compromise between various conflicting design objectives, including the largest possible field of view (FoV), the widest possible working range and/or spectral range, sensitivity, temporal resolution, etc.

For example, a front camera system in modern vehicles poses high requirements on the horizontal field of view and the working range or range. These requirements are so incompatible that they usually cannot be met by a single camera. Typical camera systems installed in driver assistance systems are therefore so-called multi-purpose camera systems. These multi-purpose camera systems are usually arrangements or clusters comprising a plurality of cameras of different specifications. For example, the area of front cameras requires camera systems that, on the one hand, have a horizontal field of view of at least 100° in order at an early stage to detect lateral movements crossing the vehicle's path, but, on the other hand, must be able to resolve objects at great distances such that they can be recognized. This is the reason for using camera clusters that combine cameras with a field of view of up to 150°, so-called fisheye lenses, and 28° telephoto cameras for higher resolution at further distances.

A key problem with using telephoto cameras is a limitation in resolution due to motion blur. Motion blur occurs when the camera or the recorded scene is not stationary at the time of recording, more precisely: during the exposure time. Camera rotations, lateral object movements, and long exposure times have the strongest influence on motion blur. For assessing the influence of motion blur, the angular image resolution Rₐ is used, which is specified in the dimensionless pseudo-unit pixels per degree (ppd). The angular image resolution specifies how many pixels (unit [px]) are available to represent a 1° wide scene. The greater Rₐ, the more detailed the representation. A 28° telephoto camera with a 2-megapixel Full HD image processor would therefore have an angular image resolution of:

$${R}_{a} = \frac{1920 px}{28 °} = 68.6 ppd \qquad ( 1 )$$

Based on empirical experience, a pedestrian is classified as “small” in computer-aided object recognition if their size on the camera recording is less than 45 px. This size in combination with an estimated average height of a pedestrian of 1.7 m and a typically required recognition distance of 200 m results in a necessary angular image resolution of:

$${R}_{a , min} = \frac{45 px}{\frac{1.7 m 180 °}{200 m π}} = 92.4 ppd \qquad ( 2 )$$

An analogous consideration for vehicles instead of pedestrians results in R_{a,min}=93.1 ppd. It follows therefrom that a 2-megapixel image processor is not sufficient for the specified requirements, but rather a 4-megapixel image processor must be used, which is already a high technical requirement. However, this resolution initially only applies to a stationary camera in a still scene.

A particular challenge is that the effective image resolution of a camera system with high angular image resolution drops significantly if the camera or the scene is moving during the exposure time. For example, a moderate movement of the camera in relation to reality of ω=5°/s and an exposure time of t=10 ms at an angular image resolution of Rₐ=93.1 ppd result in a motion blur dp of:

$$dp = 5 ° / s \times 10 ms \times 93.1 ppd = 4.7 px \qquad ( 3 )$$

This means that details that would normally be resolved to a single pixel now amount to approximately 5 px. Consequently, in the case of moderate motion, the effective angular image resolution is reduced by a factor of almost 5, a circumstance that cannot be circumvented in a technically feasible manner by increasing the image processor resolution. Empirical experience also shows that real camera movements in moving vehicles can be up to 20°/s. Such considerations make it necessary to consider performance indicators other than image processor resolution when designing camera systems.

An object of the present invention is to set an exposure time of a camera of the camera system with which a specified angular image resolution is maintained when the camera system is moving and/or in a moving scene. In order to achieve the object, a method of the present invention provided. Preferred embodiments of the present invention are disclosed herein.

### SUMMARY

The present invention provides a method is provided for determining an exposure time t for a camera of a camera system that is moving and/or used in a moving scene for automatic object recognition, wherein a specified minimum angular image resolution R_{a*} is maintained. According to an example embodiment of the present invention, the method includes:
a) determining an effective image resolution R_{a,eff}(t) as a function of the exposure time t,
b) determining a maximum permissible exposure time tₘₐₓ as the exposure time with which the effective image resolution R_{a,eff}(t) takes the value of the minimum angular image resolution R_{a*}, and
c) setting the exposure time t to a value less than or equal to the maximum permissible exposure time tₘₐₓ.

Steps a) and b) are carried out in any order, followed by step c). The proposed method allows for a specified minimum angular image resolution R_{a*} to be maintained with a moving camera and/or in a moving scene. The specified minimum angular image resolution R_{a*} results from an external requirement on the camera system, for example on the basis of a technical function or task to be fulfilled. The effective angular image resolution R_{a,eff}(t) is inversely proportional to the exposure time t:

$${R}_{a , eff} ( t ) = K \frac{1}{t} \qquad ( 4 )$$

where K corresponds to an inverse proportionality factor. This factor can be determined empirically, modeled, or defined in another way. From the requirement

$${R}_{a , eff} ( {t}_{max} ) = {R}_{a *} \qquad ( 5 )$$

and the corresponding solution of equation (4) follows the maximum permissible exposure time tₘₐₓ.

According to an example embodiment of the present invention, it is furthermore provided that, in step a), the effective image resolution R_{a,eff}(t) is also determined depending on a maximum tolerated motion blur dp and a movement variable ω_{K}. The movement variable ω_{K} is an overall quantification of a camera movement and/or a movement of the scene to be recorded. Since every movement can be represented as a change in the camera's viewing angle, the movement variable ω_{K} is preferably given as the angular velocity in degrees per second [°/s]. This preferred embodiment provides the method with accessibility to probabilistic motion models, whereby a real scene and/or camera movement can be represented more accurately than by estimation or averaging. With this preferred embodiment, equation (4) is continued to:

$${R}_{a , eff} ( t ) = \frac{dp}{{ω}_{K}} \frac{1}{t} \qquad ( 6 )$$

where the maximum tolerated motion blur dp is preferably measured in pixels. The magnitude of a movement ω, for example, a camera movement or a scene movement, at a certain point in time is given by the Euclidean norm of a superposition of three movements ωₓ, ω_{y}, and ω_{z} in three linearly independent spatial directions x, y, and z:

$$ω = \sqrt{{ω}_{x}^{2} + {ω}_{y}^{2} + {ω}_{z}^{2}} \qquad ( 7 )$$

The movement variable ω_{K} to be used to determine a total effective image resolution R_{a,eff}(t), as a quantification of the expected movement, represents a reduction of all camera and/or scene movements ω to a single estimate. This estimate may, for example, be a mean, an estimate on the safe side in the form of a maximum value, a statistically expected value, or similar.

In addition, according to an example embodiment of the present invention, it is provided that the movement variable ω_{K} is modeled as a probability distribution of an angular velocity related to the camera system. With this preferred embodiment, a real scene and/or camera movement can be represented more accurately than, for example, by estimation or averaging. For determining the shape of the probabilistic distribution of the camera and/or scene movements ω, measurement runs can be carried out in advance, for example, and measurement data can be evaluated. In this case, with the movement variable ω_{K}, a percentage of cases is preferably estimated to be on the safe side. This means that the movement variable ω_{K} is preferably chosen such that 99.7% of all occurring camera and/or scene movements ω are less than or equal to the movement variable ω_{K} in terms of magnitude.

In a development of the present invention, it is provided that the probability distribution is modeled as a Gaussian normal distribution. This preferred embodiment of the present invention allows for realistic modeling of the camera and/or scene movements typical for vehicles in traffic. A Gaussian normal distribution is also analytically straightforward because it only depends on a mean and a standard deviation. In a preferred embodiment, a mean of zero is chosen. In connection with the fact that, with the movement variable ω_{K}, 99.7% of all occurring movements ω are preferably estimated on the high side, the following results for the movement variable ω_{K}:

$${ω}_{K} = 3 {σ}_{ω} \qquad ( 8 )$$

where σ_{ω} corresponds to a standard deviation of the Gaussian normal distribution. In a preferred embodiment, the standard deviation is chosen to be σ_{ω}=2°/s.

According to an example embodiment of the present invention, it is further provided that the following steps be carried out before step c):
i) determining an effective signal-to-noise ratio S/D_{eff}(t) as a function of the exposure time t, and
ii) determining a minimum exposure time tₘᵢₙ to be maintained as the exposure time t with which the effective signal-to-noise ratio S/D_{eff}(t) takes the value of a predetermined minimum required signal-to-noise ratio S/D_{*}.

This preferred embodiment of the present invention is advantageous because exposure times that are too short cause noise-corrupted images. The greater the corruption by noise, the lower the robustness of subsequent computer-aided object recognition. This preferred embodiment therefore ensures that, when determining the exposure time according to a method according to the present invention, it is recognizable if the choice of the exposure time t can have negative effects on subsequent object recognition. The dimensionless, minimum required signal-to-noise ratio S/D_{*} is preferably predetermined on the basis of the needs of a computer-aided object recognition algorithm to be used. The effective signal-to-noise ratio S/D_{eff}(t) as a function of the exposure time t can be determined in many ways. A preferred embodiment is shown below by way of example. Preferably, the effective signal-to-noise ratio S/D_{eff}(t) is expressed on the basis of a radiation energy per pixel Qₚ, measured in watt-seconds [Ws], as follows:

$${Q}_{p} = \frac{{Q}_{0}}{{η}_{q}} {( S / N )}^{2}$$

where an average photon energy and a quantum yield are preferably chosen to be Q₀=2.2 eV and η_{q}=0.9, respectively. At the same time, the radiation energy per pixel Qₚ can be expressed on the basis of an image irradiance Eᵢ and the applicable pixel pitch p for the relevant image processor (unit typically in [μm]) as a function of the exposure time t as follows:

$${Q}_{p} = {E}_{i} {p}^{2} t \qquad ( 10 )$$

The image irradiance Eᵢ, measured in [W/m²], can be measured or estimated analytically using simplifying assumptions such as the Lambertian reflection conditions. Otherwise, it depends only on known variables, including the f-number of the camera used and the expected light intensity of the scene observed. A possible determination of the image irradiance Eᵢ is described in Jähne et al. 1999, Handbook of Computer Vision and Applications, Volume 1. Eᵢ can thus, for example, be calculated using the formula:

$${E}_{i} = \frac{{L}_{e} π}{4 {n}_{f}^{2}} \qquad ( 11 )$$

where Lₑ corresponds to a radiation of a Lambertian object surface in the unit watt per steradian per square meter [W/(sr m²)] and n_{f} represents the f-number of the camera. Equating equations (9) and (10) results in a function of the effective signal-to-noise ratio as a function of the exposure time t:

$$S / {D}_{eff} ( t ) = \sqrt{\frac{{η}_{q}}{{Q}_{0}} {E}_{i} {p}^{2} t} \qquad ( 12 )$$

From the requirement

$$S / {D}_{eff} ( {t}_{min} ) = S / {D}_{*} \qquad ( 13 )$$

and corresponding solution of equation (12) follows the minimum exposure time tₘᵢₙ to be maintained.

According to an example embodiment of the present invention, it is also provided that, in step c), the exposure time t is also set to a value greater than or equal to the minimum exposure time tₘᵢₙ to be maintained. This preferred embodiment ensures that the exposure time t ensures sufficient angular image resolution, yet at the same time the resulting images have sufficient quality for robust computer-aided object recognition.

In addition, according to an example embodiment of the present invention, a camera system comprising at least one camera is provided, wherein, according to the present invention, the camera is gimbal-mounted for the purpose of image stabilization in favor of longer possible exposure times and an exposure time t of the camera is preset according to a method according to the present invention. A camera system of this type has the aforementioned advantages. In particular, the gimbal mount reduces camera movement and stabilizes the image. With reduced camera movement, longer exposure times cause less motion blur. At the same time, longer exposure times lead to a lower signal-to-noise ratio, which has a positive effect on the robustness of computer-aided object recognition.

According to an example embodiment of the present invention, it is also provided that the gimbal mount is designed as a motorized arm, preferably as a gimbal, comprising at least one servo motor for performing a rotational movement about a roll axis and a pitch axis. A gimbal improves the stability of recorded images when the camera is moving. With this preferred embodiment, camera movements can be reduced even further, which in turn results in less motion blur with longer possible exposure times and thus in images with a higher signal-to-noise ratio S/D and more robust object recognition.

According to an example embodiment of the present invention, it is also provided that the camera system has at least one inertial measuring unit for measuring a spatial acceleration. With the inertial measuring unit, which is preferably arranged on the camera, a movement of the camera system and/or of the at least one camera can be measured. On the basis of these measurement data, a compensating movement can be determined for any occurring movement and can be performed by means of the servo motors, whereby the image is stabilized.

Furthermore, according to an example embodiment of the present invention, it is provided that an intersection point of the roll axis and the pitch axis is coincident with a perspective center of the camera. This preferred embodiment has the result that any rotational movement of the camera caused by the motorized arm is in the image plane, thus avoiding parallactic shift effects.

According to an example embodiment of the present invention, it is also provided that the camera be equipped with a telephoto lens. This preferred example embodiment of the present invention increases the distance resolution and makes clearer and more robust object recognition at longer distances possible.

The present invention is explained in more detail below with reference to the figures.

### BRIEF DESCRIPTION OF THE DRAWINGS

FIG. 1 is a graphical representation of the relationships between angular image resolution, signal-to-noise ratio, and exposure time.

FIG. 2 is a schematic plan view of a camera of a camera system according to an example embodiment of the present invention.

### DETAILED DESCRIPTION OF EXAMPLE EMBODIMENTS

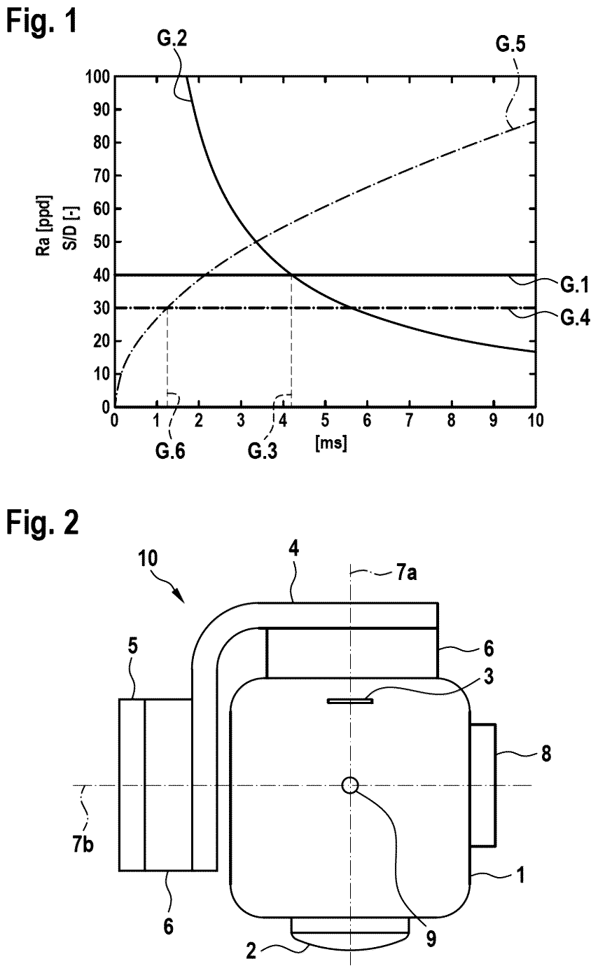

FIG. 1 is a graphical representation of the relationships between an angular image resolution R_{a,eff}(t), a signal-to-noise ratio S/D(t), and the exposure time t. A method sequence according to the present invention is illustrated below with reference to FIG. 1. From a field of application or another external specification, a minimum angular image resolution R_{a*} (represented by G.1) to be maintained is specified. In FIG. 1, it is 40 ppd, by way of example. For determining the exposure time, an effective image resolution R_{a,eff}(t) (represented by G.2) is then established as a function of the exposure time t. This function inter alia depends on a maximum tolerated motion blur dp and on a movement variable ω_{K}, which quantifies the movement of the camera and/or of a moving scene. The effective image resolution R_{a,eff}(t) (represented by G.2) is inversely proportional to the exposure time t. The intersection point of the minimum angular image resolution R_{a*} (represented by G.1) with the effective image resolution R_{a,eff}(t) (represented by G.2) results in a maximum permissible exposure time tₘₐₓ (represented by G.3), in the present example 4.2 ms. An exposure time t to be determined must therefore be less than or equal to the maximum permissible exposure time tₘₐₓ (represented by G.3) in order to meet the requirement for the minimum angular image resolution R_{a*} (represented by G.1).

Exposure times t that are too short lead to noise-corrupted images. Such corruption makes computer-aided object recognition considerably more difficult. The field of application of the camera system, usually the specific needs of an object recognition algorithm, thus results in a minimum required signal-to-noise ratio S/D_{*} (represented by G.4). In the present example, it is 30. Furthermore, an effective signal-to-noise ratio S/D_{eff}(t) (represented by G.5) is determined as a function of the exposure time t. The intersection point of the minimum required signal-to-noise ratio S/D_{*} (represented by G.4) with the effective signal-to-noise ratio S/D_{eff}(t) (represented by G.5) results in a minimum exposure time tₘᵢₙ (represented by G.6) to be maintained, in the present example 1.2 ms. An exposure time t to be determined must therefore be greater than or equal to the minimum exposure time tₘᵢₙ (represented by G.6) to be maintained, in order to meet the requirement for the minimum signal-to-noise ratio S/D_{*} (represented by G.4).

Finally, the exposure time t of the camera system is set within the interval bounded from below by the minimum exposure time tₘᵢₙ (represented by G.6) to be maintained and from above by the maximum permissible exposure time tₘₐₓ (represented by G.3).

FIG. 2 shows a camera 1 for a camera system 10 according to the present invention. The camera 1, comprising a telephoto lens 2 and an image processor 3, is mounted on a motorized arm 4. The motorized arm 4 has two servo motors 6 for transmitting rotational movements to the camera 1 on two axes (7a, 7b). One servo motor 6 is designed for performing a rotational movement about a roll axis 7a of the camera 1, the second servo motor is designed for performing a rotational movement about a pitch axis 7b of the camera 1. The intersection point of the roll axis 7a and the pitch axis 7b is coincident with the perspective center 9 of the camera 1. Furthermore, the camera 1 has an inertial measuring unit 8. The motorized arm 4 also has a base 5 for mounting on an external bracket. When the camera system 10 is moved, the inertial measuring unit 8 records the direction and magnitude of the movement. On the basis of the measurement, the servo motors 6 initiate corresponding compensating rotational movements about the roll axis 7a and the pitch axis 7b in order to keep the image stable despite movement.

1-11. (canceled)

12. A method for determining an exposure time for a camera of a camera system that is moving and/or used in a moving scene for automatic object recognition, wherein a specified minimum angular image resolution is maintained, the method comprising the following steps:
a) determining an effective angular image resolution as a function of the exposure time;
b) determining a maximum permissible exposure time as the exposure time with which the effective angular image resolution takes a value of the minimum angular image resolution; and
c) setting the exposure time to a value less than or equal to the maximum permissible exposure time.

13. The method according to claim 12, wherein in step a), the effective angular image resolution is also determined depending on a maximum tolerated motion blur and a movement variable.

14. The method according to claim 13, wherein the movement variable is modeled as a probability distribution of an angular velocity related to the camera system.

15. The method according to claim 14, wherein the probability distribution is modeled as a Gaussian normal distribution.

16. The method according to claim 11, wherein the following steps are carried out before step c):
i) determining an effective signal-to-noise ratio as a function of the exposure time, and
ii) determining a minimum exposure time to be maintained as the exposure time with which the effective signal-to-noise ratio takes a value of a predetermined minimum required signal-to-noise ratio.

17. The method according to claim 16, wherein, in step c), the exposure time is also set to a value greater than or equal to the minimum exposure time to be maintained.

18. A camera system, comprising:
at least one camera, wherein the camera is gimbal-mounted for image stabilization in favor of longer possible exposure times, and an exposure time of the camera is preset by:
a) determining an effective angular image resolution as a function of the exposure time,
b) determining a maximum permissible exposure time as the exposure time with which the effective angular image resolution takes a value of a specified minimum angular image resolution, and
c) setting the exposure time to a value less than or equal to the maximum permissible exposure time.

19. The camera system according to claim 18, wherein the gimbal mount includes a motorized arm as a gimbal, and including at least one servo motor for performing a rotational movement about a roll axis and a pitch axis.

20. The camera system according to claim 18, wherein the camera system has at least one inertial measuring unit for measuring a spatial acceleration.

21. The camera system according to claim 19, wherein an intersection point of the roll axis and the pitch axis is coincident with a perspective center of the camera.

22. The camera system according to claim 18, wherein the camera is equipped with a telephoto lens.
